(19) United States
(12) Patent Application Publication
(10) Pub. No.: US 2025/0070956 A1
(43) Pub. Date: Feb. 27, 2025

(54) ENCRYPTING AND DECRYPTING INFORMATION

(71) Applicant: INAIT SA, Lausanne (CH)

(72) Inventors: Kathryn Hess Bellwald, Aigle (CH); Henry Markram, Lausanne (CH)

(21) Appl. No.: 18/827,627

(22) Filed: Sep. 6, 2024

Related U.S. Application Data
(63) Continuation of application No. 18/161,414, filed on Jan. 30, 2023, now Pat. No. 12,113,891.
Application No. 18/161,414 is a continuation of application No. 16/356,478, filed on Mar. 18, 2019, now Pat. No. 11,569,978.

(51) Int. Cl. H04L 9/06; G06N 3/08

(52) U.S. Cl. CPC H04L 9/0618; G06N 3/08

(57) ABSTRACT

Methods, systems, and devices for encrypting and decrypting data. In one implementation, an encryption method includes inputting plaintext into a recurrent artificial neural network, identifying topological structures in patterns of activity in the recurrent artificial neural network, wherein the patterns of activity are responsive to the input of the plaintext, representing the identified topological structures in a binary sequence of length L and implementing a permutation of the set of all binary codewords of length L. The implemented permutation is a function from the set of binary codewords of length L to itself that is injective and surjective.

### CROSS-REFERENCE TO RELATED APPLICATIONS

This application is a continuation of U.S. application Ser. No. 18/161,414 filed Jan. 30, 2023, now allowed, which is a continuation of U.S. application Ser. No. 16/356,478, filed on Mar. 18, 2019, now U.S. Pat. No. 11,569,978, which are incorporated herein by reference in their entirety.

### BACKGROUND

Cryptographic encryption provides secure communications between parties even in the event that a third party (commonly called an “adversary”) intercepts the communication.

Encrypted communications are encoded such that only authorized recipient(s) can access the communications. In general, the communications themselves are referred to as “plaintext,” which is a term that encompasses both textual and other messages. The algorithm that encrypts the communications is commonly referred to as a “cipher” and the encrypted communications are referred to as “ciphertext.” Although the ciphertext may be intercepted or otherwise available to an adversary, decoding the ciphertext to access the encrypted communication is generally very difficult.

In general, encryption can be classified as “symmetric key” or “public key.” In symmetric key encryption, the same key is used for encrypting plaintext and decrypting ciphertext. Since both the sending and receiving parties must have access to the same symmetric key, the symmetric key must be exchanged over a secure channel to ensure privacy. In public key encryption, the encryption key can be published and used by many parties to encrypt plaintext. However, only the intended recipients should have access to the decryption key that enables ciphertext to be decrypting.

In any case, improved cryptographic encryption would be beneficial in many contexts, including data storage, communications, digital signatures, authentication, and electronic commerce.

### SUMMARY

This document relates to encrypting and decrypting information, and to systems and techniques that encrypt and decrypt information. For example, in one implementation, an encryption method includes inputting plaintext into a recurrent artificial neural network, identifying topological structures in patterns of activity in the recurrent artificial neural network, wherein the patterns of activity are responsive to the input of the plaintext, representing the identified topological structures in a binary sequence of length L, and implementing a permutation of the set of all binary codewords of length L. The implemented permutation is a function from the set of binary codewords of length L to itself that is injective and surjective. The method can be implemented in hardware, in software, or in a combination thereof.

This encryption method can include one or more of the following features. The method can include tailoring the response of the network to input, for example, by creating or removing a node or a link within the network or by changing one or more properties of a node or a link within the network. The method can further include receiving data characterizing tailoring a characteristic of the inputting of the plaintext into the network and tailoring the inputting of the plaintext into the network in accordance with the data. The data can characterize either synapses and nodes into which bits of the plaintext are to be injected or an order in which bits of the plaintext are to be injected. Implementing the permutation can include inputting the binary sequence and one or more codewords along a same cycle into a recurrent artificial neural network, for example, wherein the recurrent artificial neural network is the same recurrent artificial neural network into which the plaintext is input. Identifying the topological structures in the patterns of activity can include identifying simplex patterns of activity in the network, for example, wherein the simplex patterns are directed simplices or wherein the simplex patterns enclose cavities. Identifying the topological structures in the patterns of activity can include determining a timing of activity having a complexity that is distinguishable from other activity that is responsive to the input, and identifying the topological structures based on the timing of the activity that has the distinguishable complexity. The method can include encrypting second plaintext using the plaintext as a cryptographic key.

In another implementation, a decryption method can include receiving a ciphertext comprising a sequence representing patterns of activity in a recurrent artificial neural network responsive to input of corresponding plaintext into the network, repeatedly implementing a permutation of the set of all binary codewords of length L, wherein the implemented permutation is a function from the set of binary codewords of length L to itself that is injective and surjective, and implementing the permutation generates a plurality of codewords along a cycle, comparing each of the plurality of codewords to the ciphertext to identify a matching of the plurality of codewords, and designating a codeword preceding the matching of the plurality of codewords along the cycle as a plaintext corresponding to the ciphertext. The method can be implemented in hardware, in software, or in a combination thereof.

This decryption method can include one or more of the following features. The method can include using the preceding codeword as a key to decrypt a second ciphertext. The ciphertext can include a binary sequence. Digits of the binary sequence can represent simplex patterns of activity in the network. For example, the simplex patterns can be directed simplices. As another example, the simplex patterns can enclose cavities. Implementing the permutation can include inputting the ciphertext and the codewords along the cycle into a recurrent artificial neural network, identifying topological structures in patterns of activity in the recurrent artificial neural network, wherein the patterns of activity are responsive to the input, representing the identified topological structures. The method can include tailoring the response of the network to input prior to the inputting, for example, by creating or removing a node or a link within the network or by changing one or more properties of a node or a link within network. Identifying the topological structures in the patterns of activity can include determining a timing of activity having a complexity that is distinguishable from other activity that is responsive to the input, and identifying the topological structures based on the timing of the activity that has the distinguishable complexity. The method can include receiving data characterizing tailoring a characteristic of the inputting the ciphertext and the codewords and tailoring the inputting of the ciphertext and the codewords into the network in accordance with the data. The data can characterizes either synapses and nodes into which bits of the plaintext are to be injected or an order in which bits of the plaintext are to be injected.

In some cases, a non-transitory computer-readable storage medium can have instructions stored thereon that, when executed by one or more processors, cause the one or more processors to perform operations that include any of the above-described encryption and decryption methods.

In some cases, an encryption device can be configured to perform any of the above-described encryption methods. In some cases, a decryption device can be configured to perform any of the above-described decryption methods.

The details of one or more embodiments are set forth in the accompanying drawings and the description below. Other features, objects, and advantages will be apparent from the description and drawings, and from the claims.

### DESCRIPTION OF THE DRAWINGS

FIG. 1 is a schematic representation of a process for cryptographic encryption that relies upon permutation.

FIG. 2 is flow chart illustrating a permutative decryption process.

FIG. 3 is a schematic representation of a process for cryptographic encryption that relies upon permutation.

FIGS. 4 and 5 are representations of patterns of activity that can be identified and read in a recurrent artificial neural network.

FIG. 6 is a schematic representation of a determination of the timing of activity patterns that have a distinguishable complexity.

### DETAILED DESCRIPTION

Permutation encryption appears to have been practiced for thousands of years. For example, Julius Caesar is said to have invented a shift algorithm to encode messages. Regardless of the veracity of this claim, shift algorithms are still referred to as “Caesar code.” With modern computing, even more advanced forms of permutation encryption are vulnerable to cracking.

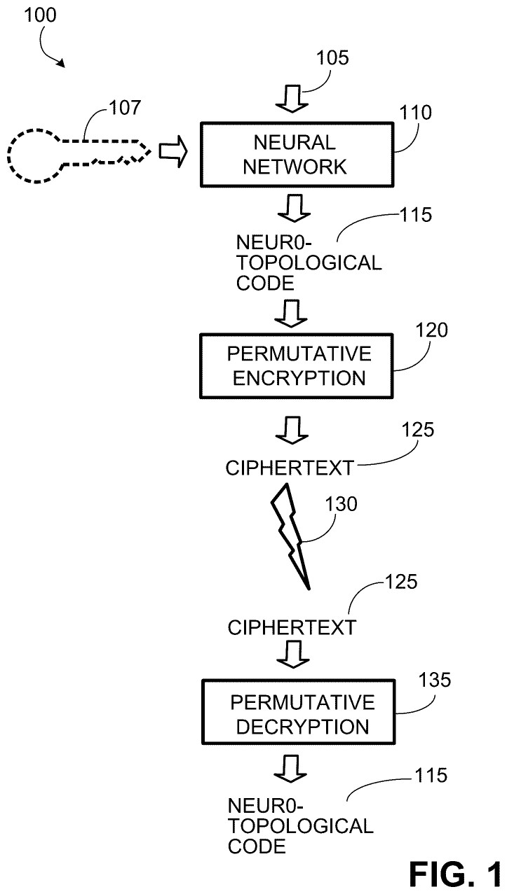

FIG. 1 is a schematic representation of a process 100 for cryptographic encryption that relies upon permutation. Process 100 relies upon the decomposition of a permutation into a product of cycles to allow a message to be encrypted and decrypted.

In more detail, in process 100, plaintext 105 is input into a recurrent artificial neural network 110. Artificial neural networks are devices that are inspired by the structure and functional aspects of networks of biological neurons but are implemented in hardware, in software, or in combinations thereof. In particular, artificial neural networks mimic the information encoding and other processing capabilities of networks of biological neurons using a system of interconnected constructs called nodes. The arrangement and strength of connections between nodes in an artificial neural network determines the results of information processing or information storage by the artificial neural network.

Neural networks can be trained to produce a desired signal flow within the network and achieve desired information processing or information storage results. In general, training a neural network will change the arrangement and/or strength of connections between nodes during a learning phase. A neural network can be considered trained when sufficiently appropriate processing results are achieved by the neural network for given sets of inputs.

Artificial neural networks can be used in a variety of different devices to perform non-linear data processing and analysis. Non-linear data processing does not satisfy the superposition principle, i.e., the variables that are to be determined cannot be written as a linear sum of independent components.

In recurrent artificial neural networks, the connections between nodes form a directed graph along a temporal sequence and the network exhibits temporal dynamic behavior.

Plaintext 105 can be input into recurrent artificial neural network 110 in a variety of different ways. In general, a user may be able to uniquely specify the ways in which plaintext is injected into a particular network to provide a level of security against undesired access. For example, recurrent artificial neural network 110 need not be constrained to receiving input over a well-defined input layer. Rather, in some implementations, a user can specify that plaintext is to be injected into specific nodes or links that are distributed throughout network 110. As another example, recurrent artificial neural network 110 need not be constrained to receiving input in a known, previously defined manner (e.g., always injecting a first bit of binary plaintext into a first node, the second bit into a second node, . . . etc.) Instead, a user can specify that certain bits in the plaintext are to be injected into synapses rather than neurons, that the order of injection need not follow the order that the bits appear in the binary plaintext, or combinations of these and other parameters.

In some implementations, plaintext 105 can be input into recurrent artificial neural network 110 that has been tailored using one or more settings 107 that tailor the response of network 110 to input. These settings can, e.g., create or remove nodes or links within network 110 and/or change the properties of individual nodes or links within network 110. For example, the settings can change the strength and/or directionality of links within network 110. As another example, the settings can change the accumulation of signals or the firing threshold in a node that operates in accordance with an integrate-and-fire model. The nature of these changes can be sufficient to tailor the responsiveness of network 110 to input in a way that is hidden from, e.g., other parties who may have access to network 110 but not to settings 107. As such, settings 107 can be considered a “private key” that-along with the unchanged properties of network 110—determines the encoding of plaintext 105. For didactic purposes, settings 107 are schematically represented as a key in FIG. 1.

In response to the input of plaintext 105, recurrent artificial neural network 110 responds with patterns of activity. The topological patterns that arise in this activity can be “read” as a neuro-topological code 115. In more detail, a neuro-topological code 115 can represent the topological features that correspond to patterns of activity that arise in a neural network when presented with a given input. In other words, the neural network can be represented as a graph. A graph is a set of nodes and a set of edges between those nodes. The nodes can correspond to, e.g., artificial neurons in a neural network. Edges can correspond to some relation between the nodes. Examples of relations include, e.g., a structural connection or activity along the connection. In the context of a neural network, artificial neurons can be related by a structural connection between neurons or by transmission of information along a structural connection. Edges can thus characterize relatively transient “activity” characteristics that occur within a defined time frame.

Neuro-topological code 115 can represent the presence or absence of topological features in the activity using a series of binary bits. The features whose presence or absence is indicated by bits in neuro-encoded plaintext 105 can be activity in, e.g., a node, a set of nodes, a set of sets of nodes, a set of edges, a set of sets of edges, and/or additional hierarchically-more-complex features (e.g., a set of sets of sets of nodes). Bits in neuro-encoded plaintext 105 generally represent the presence or absence of features that are at different hierarchical levels. For example, a first bit may represent the presence or absence of activity at a set of five nodes, whereas a second bit may represent the presence or absence of activity a set of eight nodes. In some implementations, bits may represent the presence or absence of multi-dimension simplex patterns of activity in a graph that represents the activity.

In some implementations, the bits in neuro-encoded plaintext 105 may represent information regarding the features in a graph other than the mere presence or absence of those features. For example, bits may represent that the features have are not only present but also have a threshold level of some characteristic. For example, bits can represent not only that there is simplex pattern of activity in a set of edges, but also that this activity is either above or below a threshold level of activity.

In a reductive sense, the input into neural network 110 is plain text 105 and the responsive neuro topological code 115 “encodes” plaintext 105. Further, for each implementation of process 100, neuro topological code 115 is constrained to have a defined length L-regardless of the size of plaintext 105. In other words, for each encryption and decryption in process 100, the length of neuro topological code 115 remains L. However, different implementations of process 100 (i.e., with different encryption/decryption of the same or other data) need not maintain the same length L as a constant.

In turn, neuro topological code 115 is input into a permutative encryption device 120. Permutative encryption device 120 can be implemented in hardware, in software, or in combinations thereof. Permutative encryption device 120 implements a permutation of the set of all binary codewords of fixed length L, i.e., a function from the set of binary codewords of length L to itself that is injective (has no collisions) and therefore surjective. Every permutation decomposes as a product of cycles. Permutative encryption device 120 thus transforms neuro topological code 115 into another binary codeword that lies on the same cycle as neuro topological code 115. In general, permutative encryption device 120 will be configured so that most cycles have a length greater than some fraction of L, e.g., 50%, 75%, or 90% of L.

In some implementations, permutative encryption device 120 is also a recurrent artificial neural network from which topological patterns in activity that is responsive to the input of neuro topological code 115 can be “read.” In such cases, the output of permutative encryption device 120 is yet another neuro-topological code, i.e., neuro-topological code that is responsive to the input of neuro-topological code 115. In some implementations, permutative encryption device 120 can be implemented by the same recurrent artificial neural network 110 that produced neuro topological code 115. Indeed, in some implementations, the network that forms permutative encryption device 120 can be tailored with the same settings 107 that that tailor the response of network 110. As an aside, even when the same recurrent artificial neural network 110 is used, plaintext 105 and neuro topological code 115 need not be input into the same neurons or synapses.

Because the output of permutative encryption device 120 is not necessarily another neuro topological code, the output of permutative encryption device 120 is designated as ciphertext 125. Ciphertext 125 can be securely transmitted, stored, or otherwise handled at 130. Without knowledge of the permutations performed by permutative encryption device 120 and the encoding reflected in neuro topological code 115, plaintext 105 is secure even if ciphertext 125 is intercepted or otherwise available to an adversary.

Process 100 uses a permutative decryption device 135 to reconstitute neuro topological code 115. Permutative decryption device 135 relies upon the decomposition of a permutation into a product of cycles to allow a message to be decrypted.

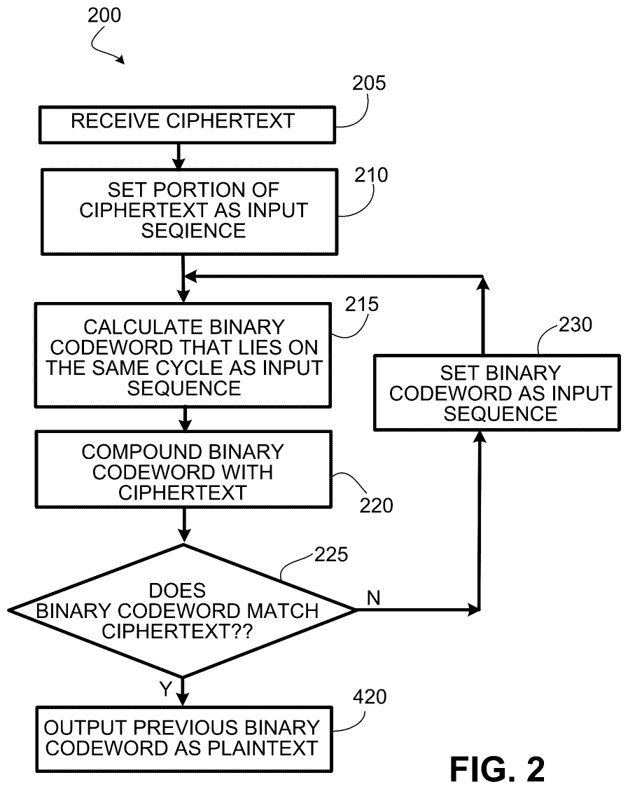

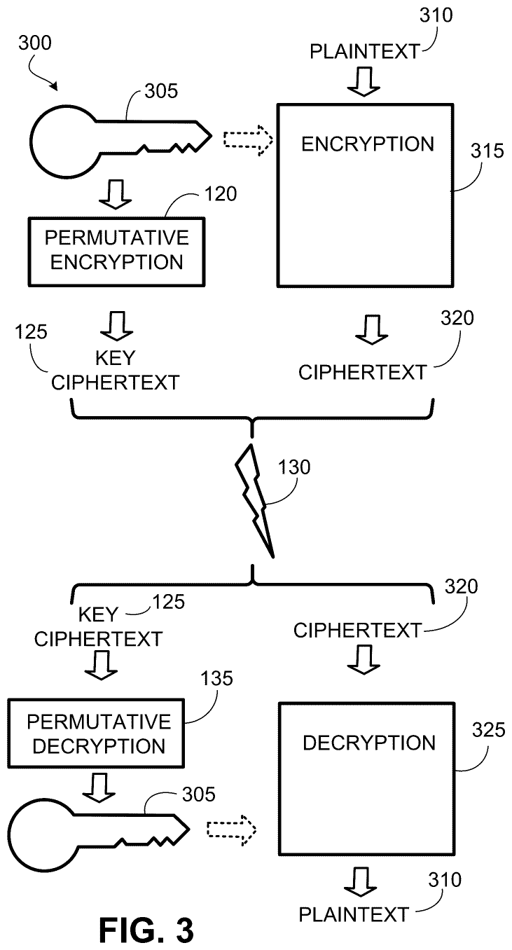

FIG. 2 is a flow chart illustrating a permutative decryption process 200. Permutative decryption process 200 can be performed, e.g., at permutative decryption device 135 (FIG. 1). As discussed further below, permutative decryption process 200 can also be performed, e.g., at permutative decryption device 135 (FIG. 3).

The system performing process 200 receives a ciphertext at 205. The ciphertext was generated at least in part by a permutative encryption process. In some implementations, the ciphertext is a neuro topological code that represents topological patterns of activity that arise in a recurrent artificial neural network in response to a given input.

The system performing process 200 selects at least a portion of the ciphertext as an input sequence at 210. In some cases, the selected portion is the entire ciphertext, although this is not necessarily the case.

When applied to an input sequence, the system performing process 200 yields a binary codeword that lies on the same cycle as the input sequence at 215. The permutation is of the set of all binary codewords of fixed length L, i.e., a function from the set of binary codewords of length L to itself that is injective (has no collisions) and therefore surjective. Each time that the process flow passes through 215, the process advances one step through the cycle.

The system performing process 200 compares the binary codeword yielded at 215 with the relevant portion of the ciphertext at 220. As discussed above, a permutation inherently decomposes into a product of cycles. Since the permutations are collision free (i.e., two different input sequences never yield the same output sequence), iterated application of the permutation to an input sequence will eventually recreate the input sequence. The comparison at 220 determines whether the ciphertext has been recreated for each given iteration of the permutation.

The system performing process 200 determines whether the binary codeword yielded at 215 matches the ciphertext at 225.

In response to a determination that the binary codeword yielded at 215 does not match the ciphertext, the system performing process 200 sets the binary codeword yielded at 215 as a new input sequence at 230 and returns to again advance another step through the cycle at 215.

This process of repeatedly applying the permutation, stepping along the cycle, proceeds until the system determines that the binary codeword yielded at 215 matches the ciphertext at 225. In response to such a determination, a codeword preceding the binary codeword yielded at the last performance of 215 by a predetermined number of steps is output. The “distance” between the output sequence and the matching sequence is the number of steps separating them along the cycle implemented by permutative encryption device 120. This number can be chosen by a user, and then implemented in the encryption and decryption devices. Further, it can be communicated from the encryption device to the decryption device in a variety of different ways. For example, the distance can be communicated to the encryption and decryption devices independently of the ciphertext, e.g., in a previous communication and/or in a communication in a different communications channel. In some instances, the distance can be set as a default, e.g., for all communications of a certain type or for all communications between a certain pair of encryption and decryption devices.

FIG. 3 is a schematic representation of a process 300 for cryptographic encryption that relies upon permutation.

In process 300, an encryption process 315 encrypts plaintext 310 using a neuro topological key 305 to generate a ciphertext 320. Encryption process 315 can be any of a variety of different processes, including those currently in use. Key 305 can be a neuro topological code such as neuro topological code 115 (FIG. 1). In other words, key 305 can represent the topological patterns in activity that arises in a recurrent artificial neural network in response to an input. The topological patterns are expressed as a binary sequence of bits. Further, in some implementations, the topological patterns can be tailored by virtue of the settings applied to the network.

In process 300, neuro topological key 305 is input into permutative encryption device 120. Like the permutative encryption device 120 in FIG. 1, permutative encryption device 120 can also be a recurrent artificial neural network from which topological patterns in activity that is responsive to the input of neuro topological code 115 can be “read” and output as a ciphertext 125 of the key 305.

Both neuro topological key 305 and plaintext 310 can be encrypted—albeit by different encryption processes 120, 315—for secure transmission, storage, or other handling at 130. Without knowledge of the permutations performed by permutative encryption device 120 and the encoding reflected in neuro topological code 305, plaintext 310 is secure even if both the key ciphertext 125 and ciphertext 320 are intercepted or otherwise available to an adversary.

Key ciphertext 125 can be decrypted using a permutative decryption device 135 to reconstitute neuro topological key 305. Permutative decryption device 135 relies upon the decomposition of a permutation into a product of cycles to allow a message to be decrypted. Permutative decryption device 135 can perform process 200 (FIG. 2).

In turn, neuro topological key 305 can be used to decrypt ciphertext 320 in a decryption process 325 and reconstitute plaintext 310.

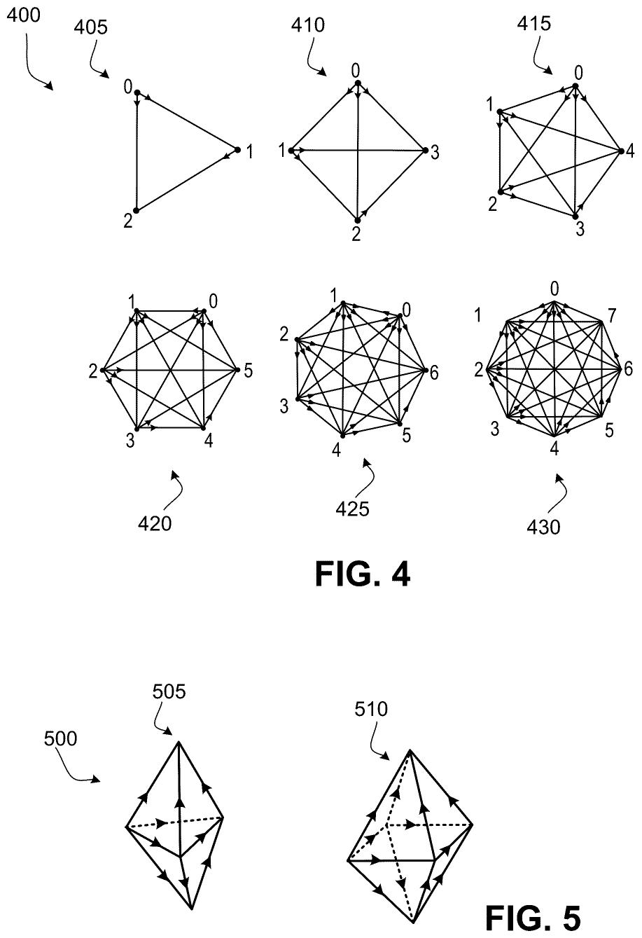

FIG. 4 is a representation of patterns 400 of activity that can be identified and “read,” e.g., as a neuro-topological code 115 from neural network 110 or permutative decryption device 135 (FIG. 1), as ciphertext 125 from permutative encryption device 120 (FIG. 1), as key ciphertext 125 from permutative encryption device 120 (FIG. 2), or as neuro topological key 305 from permutative decryption device 135 (FIG. 2).

Patterns 400 are representations of activity within a recurrent artificial neural network. To read patterns 400, a functional graph is treated as a topological space with nodes as points. Activity in nodes and links that comports with patterns 400 can be recognized as ordered regardless of the identity of the particular nodes and/or links that participate in the activity. In the illustrated implementation, patterns 400 are all directed cliques or directed simplices. In such patterns, activity originates from a source node that transmits signals to every other node in the pattern. In patterns 400, such source nodes are designated as point 0 whereas the other nodes are designated as points 1, 2, . . . . Further, in directed cliques or simplices, one of the nodes acts a sink and receives signals transmitted from every other node in the pattern. In patterns 400, such sink nodes are designated as the highest numbered point in the pattern. For example, in pattern 405, the sink node is designated as point 2. In pattern 410, the sink node is designated as point 3. In pattern 415, the sink node is designated as point 3, and so on. The activity represented by patterns 400 is thus ordered in a distinguishable manner.

Each of patterns 400 has a different number of points and reflects ordered activity in a different number of nodes. For example, pattern 405 is a 2D-simplex and reflects activity in three nodes, pattern 410 is a 3D-simplex and reflects activity in four nodes, and so on. As the number of points in a pattern increases, so does the degree of ordering and the complexity of the activity. For example, for a large collection of nodes that have a certain level of random activity within a window, some of that activity may comport with pattern 405 out of happenstance. However, it is progressively more unlikely that random activity will comport with the respective of patterns 410, 415, 420 . . . . The presence of activity that comports with pattern 430 is thus indicative of a relatively higher degree of ordering and complexity in the activity that the presence of activity that comports with pattern 405.

Different duration windows can be defined for different determinations of the complexity of activity. For example, when activity that comports with pattern 430 is to be identified, longer duration windows can be used than when activity that comports with pattern 405 is to be identified.

FIG. 5 is a representation of patterns 500 of activity that can be identified and “read,” e.g., as a neuro-topological code 115 from neural network 110 or permutative decryption device 135 (FIG. 1), as ciphertext 125 from permutative encryption device 120 (FIG. 1), as key ciphertext 125 from permutative encryption device 120 (FIG. 2), or as neuro topological key 305 from permutative decryption device 135 (FIG. 2).

Patterns 500 are groups of directed cliques or directed simplices of the same dimension (i.e., have the same number of points) that define patterns involving more points than the individual cliques or simplices and enclose cavities within the group of directed simplices.

By way of example, pattern 505 includes six different three point, 2-dimensions patterns 405 that together define a homology class of degree two, whereas pattern 510 includes eight different three point, 2-dimensions patterns 405 that together define a second homology class of degree two. Each of the three point, 2-dimensions patterns 405 in patterns 505, 510 can be thought of as enclosing a respective cavity. The nth Betti number associated with a directed graph provides a count of such homology classes within a topological representation.

The activity represented by patterns such as patterns 500 represents a relatively high degree of ordering of the activity within a network that is unlikely to arise by random happenstance. Patterns 500 can be used to characterize the complexity of that activity.

In some implementations, only some patterns of activity are identified and/or some portion of the patterns of activity that are identified are discarded or otherwise ignored during the identification of decision moments. For example, with reference to FIG. 4, activity that comports with the five point, 4-dimensional simplex pattern 415 inherently includes activity that comports with the four point, 3-dimensional and three point, 2-dimension simplex patterns 410, 405. For example, points 0, 2, 3, 4 and points 1, 2, 3, 4 in 4-dimensional simplex pattern 415 of FIG. 4 both comport with 3-dimensional simplex pattern 410. In some implementations, patterns that include fewer points—and hence are of a lower dimension—can be discarded or otherwise ignored during the identification of decision moments.

As another example, only some patterns of activity need be identified. For example, in some implementations only patterns with odd number of points (3, 5, 7, . . . ) or even numbers of dimensions (2, 4, 6, . . . ) are identified.

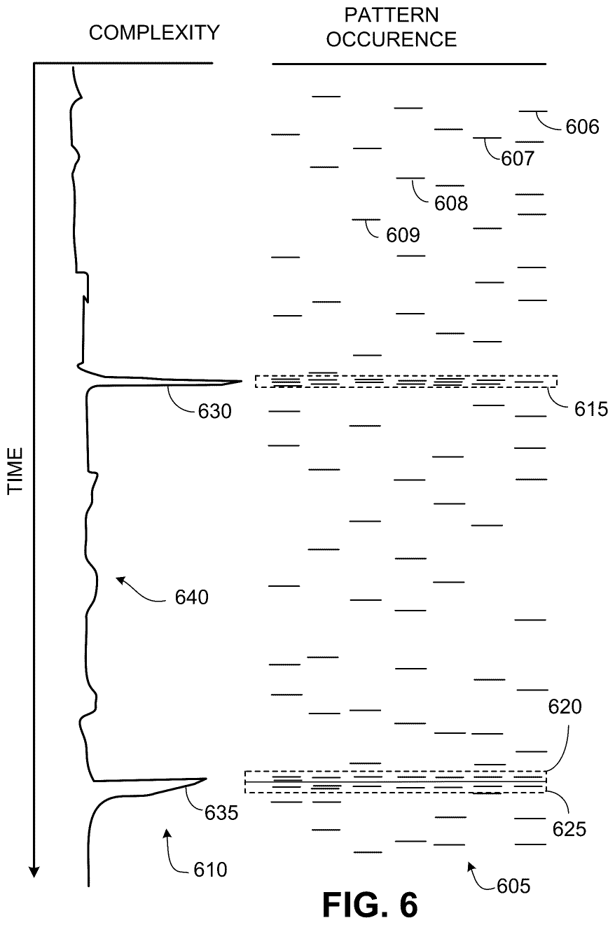

FIG. 6 is a schematic representation of a determination of the timing of activity patterns that have a distinguishable complexity. The determination represented in FIG. 6 can be performed as part of an identification or “reading” of patterns of activity. For example, the determination can be part of the output of, e.g., neuro-topological code 115 from neural network 110 or permutative decryption device 135 (FIG. 1), ciphertext 125 from permutative encryption device 120 (FIG. 1), key ciphertext 125 from permutative encryption device 120 (FIG. 2), or neuro topological key 305 from permutative decryption device 135 (FIG. 2).

FIG. 6 includes a graph 605 and a graph 610. Graph 605 represents occurrences of patterns as a function of time along the x-axis. In particular, individual occurrences are represented schematically as vertical lines 606, 607, 608, 609. Each row of occurrences can be instances where activity matches a respective pattern or class of pattern. For example, the top row of occurrences can be instances where activity matches pattern 405 (FIG. 4), the second row of occurrences can be instances where activity matches pattern 410 (FIG. 4), the third row of occurrences can be instances where activity matches pattern 415 (FIG. 4), and so on.

Graph 605 also includes dashed rectangles 615, 620, 625 that schematically delineate different windows of time when the activity patterns have a distinguishable complexity. As shown, the likelihood that activity in the recurrent artificial neural network matches a pattern indicative of complexity is higher during the windows delineated by dashed rectangles 615, 620, 625 than outside those windows.

Graph 610 represents the complexity associated with these occurrences as a function of time along the x-axis. Graph 610 includes a first peak 630 in complexity that coincides with the window delineated by dashed rectangle 615 and a second peak 635 in complexity that coincides with the window delineated by dashed rectangles 620, 625. As shown, the complexity represented by peaks 630, 625 is distinguishable from what can be considered to be a baseline level 640 of complexity.

In some implementations, the times at which the output of a recurrent artificial neural network is to be read coincide with the occurrences of activity patterns that have a distinguishable complexity. For example, in the illustrative context of FIG. 6, the output of a recurrent artificial neural network can be read at peaks 630, 625, i.e., during the windows delineated by dashed rectangles 615, 620, 625.

In some implementations, not only the timing but also the content of the output of the recurrent artificial neural network is given by the activity patterns that have a distinguishable complexity. In particular, the identity and activity of the nodes that participate in activity that comports with the activity patterns can be considered the output of the recurrent artificial neural network. The identified activity patterns can thus represent the result of processing by the neural network, as well as the timing when this decision is to be read.

The content of the decision can be expressed in a variety of different forms. For example, in some implementations, the content of the decision can be expressed as a binary vector of ones and zeros, where each digit indicates whether or not a corresponding pattern is active or inactive for a pre-defined group of nodes. In such implementations, the content of the decision is expressed in binary and can be compatible with traditional digital data processing infrastructure.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations have been described. Nevertheless, various modifications may be made. For example, during permutative decryption, a number of steps can be taken along the cycle prior to any comparison of the binary codeword yielded at 215 with the ciphertext. This would reduce data processing activities, e.g., when the cycle is known to have a high length, since the initial permutations will not match the ciphertext.

Accordingly, other implementations are within the scope of the following claims.

1-18. (canceled)

19. An encryption method implemented in hardware, in software, or in a combination thereof, the method comprising:
receiving a binary sequence of length L, wherein the binary sequence represents topological structures in patterns of activity in a first recurrent artificial neural network, wherein the patterns of activity are responsive to a plaintext input into the first recurrent artificial neural network; and
implementing a permutation of a set of all binary codewords of length L to generate ciphertext of the plaintext, wherein the implemented permutation is a function from the set of binary codewords of length L to itself.

20. The method of claim 19, wherein implementing the permutation comprises inputting the binary sequence and one or more codewords along a same cycle into a second recurrent artificial neural network.

21. The method of claim 20, further comprising:
tailoring the response of the second recurrent artificial neural network to input by changing one or more properties of a node or a link within the network.

22. The method of claim 20, wherein:
the method further comprises receiving data characterizing tailoring a characteristic of the inputting of the binary sequence and one or more codewords into the second recurrent artificial neural network; and
tailoring the inputting of the of the binary sequence and one or more codewords into the second recurrent artificial neural network in accordance with the data.

23. The method claim 22, wherein the data characterizes either:
synapses and nodes into which bits of the binary sequence and one or more codewords are to be injected, or
an order in which bits of the binary sequence and one or more codewords are to be injected.

24. The method of claim 20, wherein the topological structures in the patterns of activity comprise simplex patterns.

25. The method of claim 24, wherein the simplex patterns enclose cavities.

26. The method of claim 20, wherein the method further comprises:
identifying topological structures in the patterns of activity in the second recurrent artificial neural network, wherein the patterns of activity are responsive to the input of the binary sequence and one or more codewords; and
representing the identified topological structures in the ciphertext.

27. The method of claim 26, wherein identifying the topological structures in the patterns of activity comprises:
determining a timing of activity having a complexity that is distinguishable from other activity that is responsive to the input, and
identifying the topological structures based on the timing of the activity that has the distinguishable complexity.

28. The method of claim 20, wherein:
the first recurrent artificial neural network and the second recurrent artificial neural network are a same recurrent artificial neural network; and
the plaintext is input into different neurons or synapses of the recurrent artificial neural network than the binary sequence and one or more codewords.

29. An encryption device comprising one or more computers and one or more storage devices storing instructions that are operable, when executed by the one or more computers, to cause the one or more computers to perform encryption operations, the encryption operations comprising:
receiving a binary sequence of length L, wherein the binary sequence represents topological structures in patterns of activity in a first recurrent artificial neural network, wherein the patterns of activity are responsive to a plaintext input into the first recurrent artificial neural network; and
implementing a permutation of a set of all binary codewords of length L to generate ciphertext of the plaintext, wherein the implemented permutation is a function from the set of binary codewords of length L to itself.

30. A decryption method implemented in hardware, in software, or in a combination thereof, the method comprising:
receiving ciphertext comprising a binary sequence of length L;
repeatedly implementing a permutation of a set of all binary codewords of length L, wherein the implemented permutation is a function from the set of binary codewords of length L to itself, and implementing the permutation generates a plurality of codewords along a cycle; and
designating a codeword of the plurality of codewords that precedes a codeword that matches the ciphertext as a plaintext corresponding to the ciphertext.

31. The method of claim 30, wherein digits of the binary sequence represent simplex patterns of activity in a recurrent artificial neural network.

32. The method of claim 31, wherein the simplex patterns enclose cavities.

33. The method of claim 30, wherein implementing the permutation comprises:
inputting the ciphertext and the codewords along the cycle into a recurrent artificial neural network;
identifying topological structures in patterns of activity in the recurrent artificial neural network, wherein the patterns of activity are responsive to the input; and
representing the identified topological structures.

34. The method of claim 33, further comprising:
tailoring the response of the network to input prior to the inputting by changing one or more properties of a node or a link within network.

35. The method of claim 33, wherein identifying the topological structures in the patterns of activity comprises:
determining a timing of activity having a complexity that is distinguishable from other activity that is responsive to the input, and
identifying the topological structures based on the timing of the activity that has the distinguishable complexity.

36. The method of claim 33, wherein:
the method further comprises receiving data characterizing tailoring a characteristic of the inputting the ciphertext and the codewords; and
tailoring the inputting of the ciphertext and the codewords into the network in accordance with the data.

37. The method claim 36, wherein the data characterizes either:
synapses and nodes into which bits of the plaintext are to be injected, or
an order in which bits of the plaintext are to be injected.

38. A decryption device comprising one or more computers and one or more storage devices storing instructions that are operable, when executed by the one or more computers, to cause the one or more computers to perform decryption operations, the decryption operations comprising:
receiving ciphertext comprising a binary sequence of length L;
repeatedly implementing a permutation of a set of all binary codewords of length L, wherein the implemented permutation is a function from the set of binary codewords of length L to itself, and implementing the permutation generates a plurality of codewords along a cycle; and
designating a codeword of the plurality of codewords that precedes a codeword that matches the ciphertext as a plaintext corresponding to the ciphertext.
